(19) United States
(12) Patent Application Publication
(10) Pub. No.: US 2003/0186045 A1
(43) Pub. Date: Oct. 2, 2003

(54) Built-up roof system

(76) Inventors: Trevor Wardle, Ashland, KY (US); Michael James Ennis, Reynoldsburg, OH (US); Jeffrey M. Hansbro, Sanford, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/376,468

(22) Filed: Feb. 28, 2003

Related U.S. Application Data
(63) Continuation-in-part of application No. 10/138,146, filed on May 3, 2002.
(60) Provisional application No. 60/294,829, filed on May 31, 2001.

(51) Int. Cl. B32B 3/00; B32B 3/26; B32B 9/00

(52) U.S. Cl. 428/316.6; 428/304.4; 428/318.4

(57) ABSTRACT

The present invention is an improved built-up roof system comprising an insulation layer, a coverboard layer, and a waterproofing membrane layer, wherein the coverboard layer comprises polyester foam.

### CROSS REFERENCE STATEMENT

This application is a continuation-in-part of U.S. application Ser. No. 10/138146, filed May 3, 2002, which claims the benefit of U.S. Provisional Application No. 60/294,829, filed May 31, 2001.

The present invention relates to built-up roof systems comprising an insulation layer, a coverboard layer, and a waterproofing membrane layer as well as a laminate of polyester foam and insulation foam for use in preparing such a built-up roof system and a process for preparing such a built-up roof system.

### BACKGROUND

Low pitch roofs or built-up roofs (BUR) are commonly constructed by installing an insulation layer on a roof deck, a coverboard layer over the insulation layer, followed by a waterproofing membrane layer. The waterproofing membrane layer can be composed of many different materials and is typically composed of asphalt and asphalt impregnated fiberglass ply sheet or modified bitumen. The coverboard layer most commonly is composed of fiberboard, perlite board or gypsum board. The coverboard layer protects the insulation layer from heat distortion, which can occur upon the application of hot asphalt, and reduces the risk of moisture entrapment between the waterproofing membrane layer and the insulation layer. However, current coverboard materials are not very moisture resistant, and moisture trapped between the waterproofing membrane layer and the coverboard layer within the BUR can cause roof delaminations and premature failures.

Other materials have been used in roofing applications as discussed in U.S. Pat. No. 4,418,108 and U.S. Pat. No. 6,067,770. U.S. Pat. No. 4,418,108 discloses polyethylene terephthalate (PET) films used as a perforated sheet in a roofing panel. Additionally, U.S. Pat. No. 6,067,770 relates to multi-layer polymer systems, including PET, used to prevent condensation in buildings. However, these materials do not have the needed high temperature resistance and/or have not been utilized in a BUR system.

Therefore, there remains a need for a BUR system with increased resistance to moisture, delamination and failures.

### SUMMARY

The present invention is an improved BUR system, wherein the coverboard layer comprises polyester foam sheet. The polyester foam sheet is very moisture resistant and can be directly applied to the insulation layer prior to the roofing process. This eliminates the separate step of installing the coverboard during roof construction.

In a first aspect, the present invention is a built-up roof system comprising an insulation layer, a coverboard layer, and waterproofing membrane layer oriented such that the coverboard layer is between the insulation layer and waterproofing membrane, an improvement wherein the coverboard layer comprises a polyester foam.

In a second aspect, the present invention is a process for preparing the built-up roof system of the first aspect, said process comprising applying to a roof deck, in order, an insulation layer, a polyester foam coverboard layer and a waterproofing membrane layer. One particularly desirably embodiment of the second aspect includes applying a second polyester foam layer between the roof deck and the insulation layer.

In a third aspect, the present invention is a laminate comprising a PIR insulation foam layer sandwiched between two polyester foam layers.

### DETAILED DESCRIPTION

In a BUR system comprising an insulation layer, a coverboard layer, e.g. fiber board, perlite board or gypsum board, and a waterproofing membrane layer, the present invention is an improvement, wherein the coverboard layer comprises a polyester foam instead of fiber board, perlite board or gypsum board. Preferably the polyester foam is a foam sheet. The polyester foam coverboard utilized in the present invention is lighter in weight and has much lower water absorption than currently used materials in BUR systems.

The insulation layer used in the BUR system of the present invention can be any insulation useful in roofing applications and is typically a foamed insulation material. Such insulation includes, but is not limited to, polyisocyanurate foams, extruded polystyrene foam insulation, expanded polystyrene foam insulation, extruded polypropylene foam, expanded polypropylene foam and phenolic foams. These foam insulations and their methods of manufacture are well known in the art.

The insulation layer may be any thickness in the built-up roof application. Typically, the BUR contains sufficient insulation to meet local building codes. Preferably, the BUR achieves an R15 rating as determined according to ASTM C-518. As known in the art, this rating, or any desired rating, can be achieved by various thicknesses depending on the insulation material used.

The polyester foam generally has a thickness of 0.02 inches (0.5 millimeter (mm)) or more. Conceivably, there is no upper limit on how thick the polyester foam can be. Thinner foams are easier to handle, particularly if they can be stored and handled in roll form. Therefore, the polyester foam is preferably a foam sheet. Herein, a “polyester foam sheet” refers to a polyester foam having a thickness of 0.02 inches (0.5 mm) or more, more preferably 0.04 inches (1 mm) or more and 0.25 inches (6.35 mm) or less.

The polyester foam layer can be made from any polyester that has good heat and moisture resistance. For example, high-molecular weight chain esters obtained by reacting an aromatic dicarboxylic acid and a dihydric alcohol can be used. The aromatic dicarboxylic acid may be terephthalic acid, isophthalic acid, 2,6-naphthalenedicarboxylic acid, diphenyl ether dicarboxylic acid, diphenylsulfonedicarboxylic acid, diphenoxydicarboxylic acid and the like. The dihydric alcohol can be ethylene glycol, trimethylene glycol, tetramethylene glycol, neopentylene glycol, hexamethylene glycol, cyclohexanedimethylol, tricyclodecanedimethylol, 2,2-bis-(4-beta-hydroxyethoxyphenyl) propane, 4,4′-bis(beta-hydroxyethoxy)diphenylsulfone, diethylene glycol, their respective esters, and the like. Polyethylene terephthalate (PET) and polybutylene terephthalate are preferred. The polyesters may be used singly or in any mixture thereof.

Methods of making polyester foam and foam sheet are well known in the art such as in U.S. Pat. No. 5,340,846; U.S. Pat. No. 5,000,991; U.S. Pat. No. 5,362,763; U.S. Pat. No. 5,422,381 and U.S. Pat. No. 5,958,164 which are incorporated herein by reference.

In the BUR of the present invention, the polyester of the foam preferably has a crystallinity of 20 to 35 percent (%). In other words the polyester will have 20% to 35% crystalline structure within an amorphous phase, wherein the amorphous phase makes up the balance. Increasing the crystallinity of a polyester foam increases its resistance to thermal deformation. A crystallinity of 20% or more is desirable to resist deformation during application of membrane materials, which can be at temperatures up to 500 degrees Fahrenheit (° F.), or 260 degrees Celsius (° C.) or more during application. Lower crystallinity foams are suitable for BURs that utilize membrane materials that can be applied at lower temperatures. In general, the polyester foam should have sufficient crystallinity so as to not deform during application of membrane materials. Polyester foams having a crystallinity above 35% tend to get brittle which makes damaging during handling more likely than foams with a lower crystallinity. While polyester foams having a crystallinity above 35% can be used in the present invention, they are not preferred.

A polyester foam's crystallinity is dependent upon the foam's heating history. In other words, the crystallinity varies by the type and temperature of the heating media and the contact conditions of the foam with the heating media. Typically, crystallization is accomplished by holding the polyester foam at a temperature between 30020 F. (149° C.) and 380° F. (193° C.) for a duration of between 2 and 6 seconds. However, any foam that inhibits heat transfer during the initial cooling of the foam after formation will crystallize to some degree, since the foam passes within the above conditions. Foam sheet is desirable because its thickness allows for rapid heating during the crystallization process.

Any method of heating can be utilized to establish crystallinity. In one embodiment for foam sheet, a cylindrical sheet is heated by placing a mandrel heated with heat transfer oil inside the cylinder and allowing the sheet to proceed along the mandrel having a length as long as possible. In another embodiment, a flat sheet or board can be placed between a pair of rollers heated with heat transfer oil and allowed to proceed while heating, wherein the diameters of the rollers are as large as possible.

Determine percent crystallinity from the crystallinity fraction (X_{c}) using to the following formula:

Percent crystallinity=100(X_{c})=100(Δ_{fus}H)/(Δ_{fus}H⁰)

Wherein Δ_{fus}H is the heat of fusion of the polyester foam (as determined by calorimetry) and Δ_{fus}H⁰ is the heat of fusion for the fully crystalline polyester material. Δ_{fus}H⁰ is often available in readily available reference tables. Alternatively, Δ_{fus}H⁰ can be determined using one of the methods described by H. G. Ferguson et al. (Thermochimica Acta 363 (2000) page 8 section 3.1.1., incorporated herein by reference) and references cited therein.

The polyester foam typically has a density of 0.04 to 0.3 grams per cubic centimeter (g/cm³). Decreasing a foam's density typically lowers the foam's cost and increases the foam's thermal insulating ability, both of which are desirable. Increasing a foam's density typically enhances the foam's compressive strength thereby enhancing the load that can be placed upon the foam without deforming the foam. High compressive strengths are desirable. Preferably, the polyester foam has a density of 0.06 g/cm³ or more and 0.25 g/cm³ or less.

The polyester foam is typically a closed cell foam with an average cell size of from 0.0002 to 0.020 inches (0.005 to 0.5 mm). Cell sizes of 0.005 to 0.010 inches (0.1 to 0.25 mm) are typical for a foam of uniform thickness, composition, and appearance and can be produced using blowing agents and nucleators known in the art.

Polyester foam for use in the present invention can be made from recycled material as taught in WO 90/10667. Dried scrap PET is reacted with a polyfunctional carboxylic acid anhydride such as pyromellitic acid dianhydride and trimellitic acid anhydride, in amounts of 0.05% to 2.5% by weight of the PET, at a temperature between 250 and 300° C., to obtain a composition of modified PET with a higher viscosity. This material can then be foamed by methods known in the art. PET foam for use in the present invention can include up to and including 100% recycled PET.

Polyester foam can be applied to one or both surfaces of the insulation layer. When polyester foam is only on one surface, position the insulation layer between the polyester foam and a roof deck during installation. The polyester foam can be adhered or laminated to the insulation layer prior to or during construction of the BUR system so as to form an intimately bonded preformed laminate. In a preferred embodiment, the polyester foam is applied directly to or laminated to the insulation layer prior to roof construction. This eliminates the onsite installation of the coverboard separate from the insulation layer in the roofing construction process. Lamination of the polyester foam to the insulation layer to form a laminated composite structure can be achieved by any foam lamination method and is dependent upon the material used for insulation, i.e. polyisocyanurate foams may not require any additional process or adhesive if the polyisocyanurate foam is formed in contact with the polyester foam. Typical processes for adhesion include heat fusion, adhesives, and co-extrusion.

If the polyester foam is installed on site to the insulation layer during roof construction, the foam can be either adhered or mechanically attached to the insulation layer. That is, an adhesive can be used to adhere the foam sheet to the insulation, or by mechanical means, such as screws, nails, etc. can be used to attach the foam to the insulation and the roof deck.

Preferably, the polyester foam and insulation layer are a laminated composite structure. In one embodiment the laminated composite structure has an insulation layer with a polyester foam adhered to one surface of the insulation foam. Typically, another facer material such as aluminum foil, glass fiber, Kraft paper, or a combination thereof is adhered to a surface of the insulation layer opposite the polyester foam. Desirably, the facing material on the opposite surface of the insulation layer has a similar, preferably the same coefficient of thermal expansion as the polyester foam, particularly when fabricating laminated composite structures with polyisocyanurate (PIR) foam insulation layers. Of importance is a coefficient of thermal expansion of a facer material structure at an interface between the facer material and insulation layer. “Facer material structure” refers to, e.g., a foam as opposed to a polymer in the foam. PIR foam tends to produce heat for a period of time after manufacture due to an exothermic chemical reaction during PIR foam polymerization. If the facer materials on opposing surfaces of the PIR foam insulation layer in a laminated composite have different coefficients of thermal expansion then the laminate composite can experience bowing or warping as the PIR foam heats and then cools after manufacture.

In a particularly desirable embodiment, a laminated composite structure comprises an insulation layer with polyester foam as a facer on both opposing surfaces of the insulation layer. In this embodiment, one polyester foam face acts as a coverboard layer while the other polyester foam resides between the insulation layer and a roof deck. The polyester foams on the opposing faces can be the same or different (e.g., same or different thickness). Preferably, use foam polyester foam having the same physical properties on both opposing surfaces of the insulation layer. A laminated composite structure having polyester foam on both opposing surfaces of an insulation layer is advantageous because it tends to have greater thermal dimensional stability as well as a lower thermal conductivity as compared to a laminated composite structure having a polyester foam on only one surface. Lower thermal conductivity values are particularly desirably for laminated composite structures comprising PIR foam insulation layers that are free of halogenated blowing agents. PIR foam that is free of halogenated blowing agents tends to have a higher thermal conductivity than PIR foam containing halogenated blowing agents.

It is suitable to fabricate laminated composite structures containing a polyester foam facer and a PIR foam insulation layer according to well known PIR foam fabrication art by substituting a polyester foam for one or both facer materials. For example, U.S. Pat. No. 5,308,883 (incorporated herein by reference) teaches how to prepare PIR foam containing facers using both a constrained rise and a free rise process.

The polyester foam on an insulation layer surface remote from the roof deck, i.e. the coverboard layer, is covered by a waterproofing membrane layer which can be any material (“membrane material”) which is moisture resistant and will meet the standards specified in ASTM E-108 for fire resistant materials. Typically, these materials are bitumen materials, including asphalt and coal tar type bitumen. The bitumen can be modified bitumen, which is bitumen blended with a polymer material such as styrene/butadiene/styrene block copolymers, atactic polypropylene polymers, and ethylene/styrene copolymers or “interpolymers”. An accepted procedure for applying membrane materials to a polyester foam on a roof include alternately layering a bitumen material and a reinforcing material (such as glass fiber or glass fiber mat) to achieve 3-4 plies of the bitumen/reinforcing material. A final bitumen layer (flood coat) is applied over the 3-4 plies and a coating of pea gravel it typically applied to the final bitumen layer. Membrane materials can be applied as pre-manufactured rolls that contain bitumen (or modified bitumen) and reinforcing materials by rolling the pre-manufactured materials onto a polyester foam and sealing seams with bitumen.

A skilled artisan can identify many different methods of applying membrane materials over the polyester foam to achieve the present invention. In general, prepare the built-up roof system of the present invention by applying, in order, an insulation layer, a polyester foam layer and a waterproofing membrane layer over a roof deck so that the insulation layer is most proximate to the roof deck. A second polyester foam layer can be applied between the roof deck and insulation layer. Desirably, application of the insulation layer and polymeric foam coverboard layer occurs simultaneously by applying a laminate of polyester foam and insulation layer material to a roof deck. The laminate can include a second polyester foam layer positioned so that polyester foam layers sandwich the insulation layer. Preferably, the insulation layer is PIR foam.

The following examples are provided to illustrate the present invention. The examples are not intended to limit the scope of the present invention and they should not be so interpreted. Amounts are in weight parts or weight percentages unless otherwise indicated.

### EXAMPLE 1

PET foam sheet (2.5 mm thick, density of 0.13 g/cm³ as determined according to ASTM-D1622, and 0.6 meter (m) wide by 1.2 m long) is laminated to STYROFOAM™ (trademark of The Dow Chemical Company) brand extruded polystyrene foam using Ashland Chemicals adhesive Isomelt PUR™ 200. Two laminated sheets are then butted together to make a 1.2 m square block. Hot asphalt is applied to the PET foam surface of the laminated material at a temperature of 220° C. and at a rate of 2 kilograms per square meter (kg/m²). A layer of asphalt impregnated fiberglass ply sheet is then pressed into the molten asphalt and the composite is cooled.

After cooling to atmospheric temperature, there is no evidence of any physical distortion of the insulation foam. Cutting the board through sections of the composite shows no evidence of melting or color change in the polystyrene foam.

The above test is repeated with isocyanurate foam insulation and expandable polystyrene foam insulation, with similar results.

### EXAMPLE 2

Prepare two laminated composite foam structures comprising a PET foam sheet, an isocyanurate foam, and a facer according to the procedure in Example 4 of U.S. Pat. No. 5,308,883 (incorporated herein by reference) by including a facer sheet on one surface of the structure and a PET foam sheet on the other surface (see Example 3 of U.S. Pat. No. 5,308,883 for a description of how to prepare structures with two facers. Replace one of the facers with a PET foam sheet). The PET foam sheet is 1.2 m wide, 2.4 m long, 1 mm thick, 25% crystalline, and has a 0.23 g/cm³ density according to ASTM-D1622. The isocyanurate foam is 51 mm thick. The laminated composite foam structure comprises a PET foam affixed to a polyisocyanurate foam. The polyisocyanurate foam has a facer on a surface opposite the PET foam.

Butt the two laminated composite foam structures together to form a 2.4 m square block and fasten the structures to a wooden test deck using standard BUR fasteners (e.g., Olympic Fastener HD#14, 12 fasteners per structure) with the facer against the wood structure and the PET foam exposed. Hot mop asphalt (220° C.) onto the PET foam at a rate of 2 kg/m² until the PET foam is covered with asphalt. Apply a fiberglass ply sheet that meets ASTM D-2178 Type IV and Type VI specifications. Apply two more alternating layers of asphalt and fiberglass ply sheet followed by a final coat (flood coat) of asphalt. Apply pea gravel to the still soft flood coat. There is no apparent physical distortion of the laminated composite foam structure even after application of the asphalt and fiberglass plies.

Example 2 illustrates a BUR structure comprising a laminated composite structure of PET foam and insulating foam (isocyanurate foam) that is within the scope of the present invention.

### EXAMPLE 3

Prepare a three-layer laminated composite foam structure comprising a polyisocyanurate (PIR) foam between and adhered to two PET foam sheets using the restrained rise process of Example 4 in U.S. Pat. No. 5,308,883 but modified to incorporate a facer on top and bottom of the PIR foam as described in Example 3 of U.S. Pat. No. 5,308,883. Use PET foam sheet for both the top and bottom facer. Use a PET foam sheet that is one mm thick with a density of 0.23 g/cm³ (ASTM-D1622) and a crystallinity of 25 percent. The PIR foam is 51 mm thick. The laminate composite remains dimensionally stable (i.e., without visible warping or bowing) throughout fabrication and after fabrication.

Position two of the laminated composite foam structures that are 1.2 meters wide and 2.4 meters long together on a wooden test deck to form a 2.4 meter square block. One of the PET facer sheets contacts the wooden test deck and one remains exposed for each laminated composite foam structure. Fasten the laminated composite foam structures to the wooden test deck using standard BUR fastener (e.g., Olympic Fastener HD #14, 12 fasteners per structure). Hot mop asphalt (220° C.) onto the exposed PET foam facer at a rate of 2 kg/m² until the PET foam is covered with asphalt. Apply a fiberglass ply sheet that meets ASTM D-2178 Type IV or Type VI specifications. Apply two more alternating layers of asphalt and fiberglass ply sheet followed by a final coat (flood coat) of asphalt. Apply pea gravel to the still soft flood coat. There is no apparent physical distortion of the laminated composite foam structure even after application of the asphalt and fiberglass plies.

Example 3 illustrates a BUR structure comprising a symmetrical three-layer laminated composite structure of PET foam and insulating foam (isocyanurate foam) that is within the scope of the present invention. Example 3 experiences thermal dimensional stability during and after manufacture in that it does not bow after fabrication. Example 3 also demonstrates a particularly low thermal conductivity (0.14-0.13 British Thermal Units per hour per square foot per degree Fahrenheit; or 0.24-0.22 Watts per meter per Kelvin, as per ASTME method C518), illustrating the value of using two PET foam facers to enhance a composite structure's insulating ability.

What is claimed is:

1. In a built-up roof system comprising an insulation layer, a coverboard layer, and waterproofing membrane layer oriented such that the coverboard layer is between the insulation layer and waterproofing membrane, an improvement wherein the coverboard layer comprises a polyester foam.

2. The built-up roof system of claim 1, wherein the polyester foam is a polyester foam sheet.

3. The built-up roof system of claim 1, wherein the insulation comprises a polyisocyanurate foam, extruded polystyrene foam, expanded polystyrene foam, extruded polypropylene foam, phenolic foam or expanded polypropylene foam.

4. The built-up roof system of claim 1, wherein the coverboard layer and the insulation layer are intimately bonded as a preformed laminate.

5. The built-up roof system of claim 1, wherein the polyester foam comprises polyethylene terephthalate or polybutylene terephthalate.

6. The built-up roof system of claim 1, wherein the polyester has a crystallinity of from 20 to 35%.

7. The built-up roof system of claim 1, wherein the waterproofing membrane layer comprises applications of asphalt and glass ply sheet.

8. The built-up roof system of claim 1, wherein the waterproofing membrane layer comprises modified bitumen sheet.

9. The built-up roof system of claim 1, further comprising a second polyester foam that sandwiches the insulation layer between itself and the polyester foam coverboard layer.

10. A process for preparing the built up roof system of claim 1, said process comprising applying over a roof deck, in order, an insulation layer, a polyester foam coverboard layer and a waterproofing membrane layer.

11. The process of claim 10, wherein application of the polyester foam coverboard layer and insulation layer occurs simultaneously by applying a laminate of polyester foam and insulation layer material to a roof deck.

12. The process of claim 10, further comprising applying a second polyester foam layer between the roof deck and insulation layer.

13. The process of claim 12, wherein application of the polyester foam coverboard layer, insulation layer and second polyester foam layer occur simultaneously by applying a laminate of insulation layer material sandwiched between polyester foam layers to a roof deck.

14. A laminate for use in the process of claim 12, said laminate comprising a PIR insulation foam layer sandwiched between two polyester foam layers.
